(19) United States
(12) Patent Application Publication
(10) Pub. No.: US 2008/0299833 A1
(43) Pub. Date: Dec. 4, 2008

(54) USB SOCKET, AND GAMING MACHINE INCLUDING THE SAME

(75) Inventor: Kazuaki ABE, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/122,987

(22) Filed: May 19, 2008

(30) Foreign Application Priority Data
May 30, 2007 (JP) JP2007-143399

(51) Int. Cl. H01R 24/00

(52) U.S. Cl. 439/660

(57) ABSTRACT

A USB socket is a receptacle for a directional USB plug including a male tongue provided with a first electrode terminal, and has first and second female tongues and a casing. The first female tongue has a second electrode terminal electrically connected to the first electrode terminal when the USB plug is inserted in a regular orientation, and is pushed with the male tongue in a direction of insertion when the USB plug is inserted in an inverted orientation. The second female tongue is pushed with the male tongue in the direction of insertion when the USB plug is inserted in the regular orientation, and has a third electrode terminal electrically connected to the first electrode terminal when the USB plug is inserted in the inverted orientation. The casing houses the first and second female tongues such that the second and third terminals are face with each other.

### CROSS REFERENCE TO RELATED APPLICATION

The present application claims priority from Japanese Patent Application No. 2007-143399, which was filed on May 30, 2007, the disclosure of which is herein incorporated by reference in its entirety.

### 1. FIELD OF THE INVENTION

The present invention relates to a Universal Serial Bus (USB) socket, and a gaming machine including the same.

### 2. DESCRIPTION OF RELATED ART

In the past years, there has been the emergence of a wide variety of electronic devices such as computers and computer peripherals. Among the specifications of the connectors used to connect electronic devices, one of the most common standard interface specifications is the Universal Serial Bus (USB) specification, as disclosed in JP-A-2003-068407 for example. JP-A-2003-345464 discloses an electronic device including a guide for guiding a USB plug into a USB socket.

The USB plug and USB socket have directionality. That is, the USB plug can be inserted into the USB socket only in a certain orientation.

In this connection, JP-A-2003-330573 discloses a USB plug including a projection that allows a user to feel the orientation of the USB plug by touching it.

### SUMMARY OF THE INVENTION

The foregoing technique enables a user to check the orientation of the USB plug by the modifications made to the USB plug. However, because no modifications are made to the USB socket, the user still needs to check the orientation of the USB socket when inserting the USB plug into the USB socket. This is particularly problematic when the USB socket is provided on the back of the electronic device, necessitating the user to stretch over to see the USB socket. Inserting the USB plug becomes a very annoying task in this case.

It is an object of the present invention to provide a USB socket that makes it easier for users to insert the USB plug, and a gaming machine including such a USB socket.

According to a first aspect of the present invention, there is provided a USB socket as a receptacle for a directional USB plug including a male tongue provided with a first electrode terminal, the USB socket comprising: a first female tongue having a second electrode terminal, the second electrode terminal being electrically connected to the first electrode terminal when the USB plug is inserted into the USB socket in a regular orientation, and the first female tongue being pushed with the male tongue in a direction of insertion of the USB plug when the USB plug is inserted into the USB socket in an inverted orientation; a second female tongue having a third electrode terminal, the second female tongue being pushed with the male tongue in the direction of insertion of the USB plug when the USB plug is inserted into the USB socket in the regular orientation, and the third electrode terminal being electrically connected to the first electrode terminal when the USB plug is inserted into the USB socket in the inverted orientation; and a casing housing the first female tongue and the second female tongue such that the second electrode terminal and the third electrode terminal are face to face with each other.

In the first aspect of the invention, the USB plug is inserted into the USB socket regardless of whether the USB plug is in a regular orientation or an inverted orientation. Specifically, when the USB plug is inserted into the USB socket in a regular orientation, the second female tongue of the USB socket is pushed with the male tongue of the USB plug, and the second electrode terminal of the first female tongue of the USB socket is electrically connected to the first electrode terminal of the USB plug. On the other hand, when the USB plug is inserted into the USB socket in an inverted orientation, the first female tongue of the USB socket is pushed with the male tongue of the USB plug, and the third electrode terminal of the second female tongue of the USB socket is electrically connected to the first electrode terminal of the USB plug. This eliminates the need to check the orientation of the USB socket when inserting the USB plug into the USB socket, making it easier to insert the USB plug.

According to a second aspect of the present invention, there is provided a gaming machine comprising a cabinet including the above-described USB socket on a back side of the cabinet. The gaming machine is connected to a network via the USB socket.

In the second aspect of the invention, despite that the USB socket is provided on the back side of the gaming machine, the foregoing configuration of the USB socket enables the USB plug to be easily inserted into the USB socket without the annoying task of stretching over to see the back of the gaming machine. In other words, a user is able to easily insert the USB plug.

According to a third aspect of the present invention, there is provided a gaming system comprising the above-described gaming machines. The gaming machines are disposed side by side with side faces of the cabinets facing one another.

In the third aspect of the invention, for the same reasons noted in the second aspect, the USB plug can easily be inserted into the USB socket of each gaming machine of the gaming system.

### BRIEF DESCRIPTION OF THE DRAWINGS

Other and further objects, features and advantages of the invention will appear more fully from the following description taken in connection with the accompanying drawings in which:

FIG. 1 is a perspective view of a game system according to an embodiment of the present invention including gaming machines according to an embodiment of the present invention and a hall computer connected to the gaming machines;

FIG. 2 is a perspective view showing a USB socket according to an embodiment of the present invention, along with a USB plug;

FIG. 3A and FIG. 3B are a longitudinal sectional view and a cross sectional view, respectively, of the USB socket;

FIG. 4A and FIG. 4B are a longitudinal sectional view and a cross sectional view, respectively, of an example of an conventional USB socket;

FIG. 5A and FIG. 5B are a longitudinal sectional view and a cross sectional view, respectively, of the USB plug shown in FIG. 2;

FIG. 6A, FIG. 6B, and FIG. 6C are explanatory diagrams representing how the USB plug shown in FIG. 2 is inserted into the USB socket shown in FIG. 2;

FIG. 7 is a block diagram showing an electrical configuration of the gaming machines; and

FIG. 8 is a flow chart of a main routine executed by the gaming machines.

### DESCRIPTION OF THE PREFERRED EMBODIMENTS

In the following, a certain preferred embodiment of the present invention will be described with reference to the accompanying drawings.

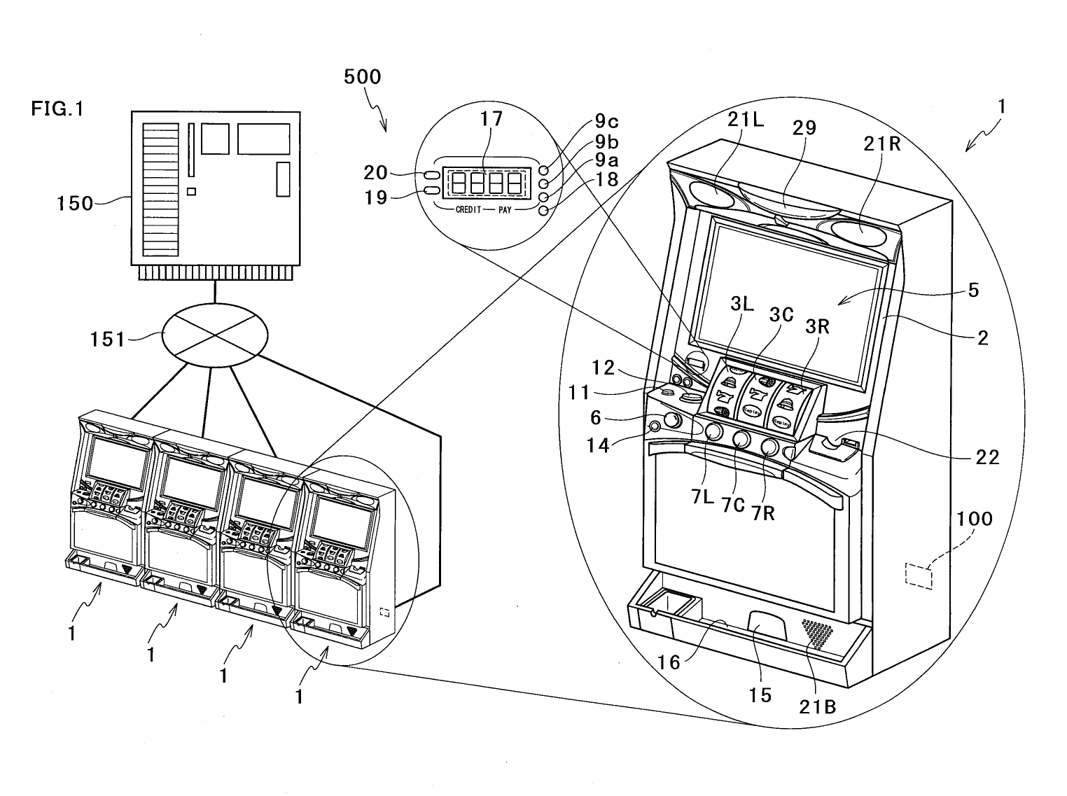

Gaming machines 1 according to an embodiment of the present invention illustrated in FIG. 1 are what is known as a “pachi-slot machine/Japanese slot-machine”. The gaming machines 1 perform symbol varying and displaying, and determine a win based on symbols that come to rest and appear on activated lines as a result of player's manipulation. The game medium used for playing the gaming machines 1 may be coins, medals, gaming balls, tokens, or the like. Other than these examples, cards storing information of game values given to or will be given to a player may be used as well. In the following, description will be given through the case where the game medium is a medal.

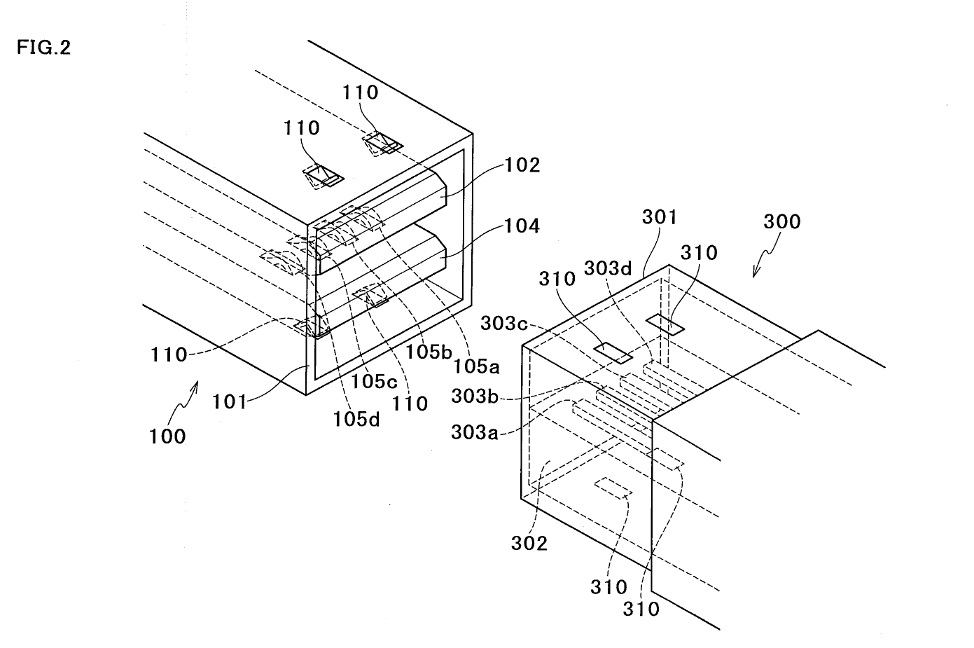

A USB socket 100 according to an embodiment of the present invention is a female connector constructed as a “Type-A socket” of the USB specification. The USB socket 100 is electrically connected to a USB plug 300 when its electrical terminals make contact with the electrical terminals of the USB plug 300 inserted into the USB socket 100. The USB plug 300 is a male connector constructed as a “Type-A terminal” of the USB specification (see FIG. 2). The USB socket 100 of the present embodiment is included in each gaming machine 1, specifically on a back side of a cabinet 2 of the gaming machine 1, as shown in FIG. 1.

The gaming machines 1 of the present embodiment are each connected to a network 151 via a network cable with a USB plug connected to the USB socket 100. Via the network 151, each gaming machine 1 is connected to a hall computer 150, which administers the game arcade. The gaming machines 1 are disposed side by side with side faces of cabinets 2 facing one another. The gaming machines 1 and the hall computer 150 constitute a game system 500 of the present embodiment.

On a front side of the cabinet 2 of each gaming machine 1 is provided a liquid crystal display 5. The liquid crystal display 5 displays various kinds of information, such as virtual reels (not shown) in synchronism with three reels 3L, 3C, and 3R provided below the liquid crystal display 5, and video effects using characters.

The outer face of each reel 3L, 3C, 3R holds a column of various symbols with code numbers “00” to “20” assigned thereto. The symbols include, for example, “red 7”, “blue 7”, “cherry”, “bell”, “watermelon”, and “Replay”, among others. Each reel 3L, 3C, 3R rotates at a constant speed, for example, at 80 rpm. The “red 7” and “blue 7” in the column of symbols can make a special win. As used herein, a “special win” refers to a win which brings a bonus such as BB (Big Bonus) or RB (Regular Bonus).

Three symbols on each reel 3L, 3C, 3R are revealed at one time, i.e., a total of nine symbols (three rows and three columns of symbols) is presented to a player in front of the cabinet 2. The reels 3L, 3C, 3R also have five pay lines, corresponding to the positions the nine symbols will come to rest on, along which a win is determined. Specifically, three horizontal lines including a top line, a center line, and a bottom line, and two diagonal lines including a cross-down line and a cross-up line are provided as the pay lines. The pay lines may or may not be visible to the player.

The pay lines are activated when the player presses a 1-BET button 11 or a maximum-BET button 12 (described later), or when the player inserts a medal to a medal insertion slot 22. Specifically, only the center line is activated when betting one medal. When betting two medals, i.e., when the 1-BET button 11 is pressed twice, or two medals are inserted, the center line, the top line, and the bottom line turn active. When betting the maximum number (three in this embodiment), all pay lines are activated. In the following, activated pay lines will be referred to as “activated lines”. When the symbols come to rest in a predetermined combination on any of the activated lines, this combination of symbols is regarded as a winning combination.

On the left of the reels 3L, 3C, 3R is provided a display unit 17. The display unit 17 is a seven-segment display, and displays at most 4-digit numbers. The upper two digits display the number of medals being reserved, i.e., the number of credits, and the lower two digits display the number of medals acquired by winning.

On the right of the display unit 17 are provided a medal insertion lamp 18, a 1-BET lamp 9a, a 2-BET lamp 9b, and a maximum BET lamp 9c. The medal insertion lamp 18 flashes when the machine is ready to accept medals. A game ends when the all reels 3L, 3C, 3R stop, or, in the case there is a payout, when the medals have been paid out. As used herein, the “payout” includes reserving medals in the gaming machine 1, and the discharge of medals through the medal discharge opening 15.

On the left of the display unit 17 are provided a game start indicator lamp 19 and a replay lamp 20. The game start indicator lamp 19 is turned on when at least one pay line is activated. The replay lamp 20 is turned on when the player wins a “Replay”, as will be described later. While the replay lamp 20 is on, a game can be started without inserting a medal.

The 1-BET button 11 and the maximum-BET button 12 are provided below the display unit 17. At every pressing of the 1-BET button 11, the medals reserved in the gaming machine 1 are bet one at a time. By pressing the maximum-BET button 12, the maximum number of medals (three in this embodiment) acceptable per play is bet. Pressing the BET buttons 11 and 12 activates the pay lines.

Below the BET buttons 11 and 12 is a C/P button 14 that is used to decide whether to reserve or discharge the medals acquired in a game. When “discharge” is selected with the C/P button 14, the medals are discharged through the medal discharge opening 15 provided at a base the cabinet 2, and are collected in a tray 16. When “reserve” is selected with the C/P button 14, the number of acquired medals is stored as credits in memory such as a RAM 33 of the gaming machine 1.

On the right of the C/P button 14 is provided a start lever 6 used to rotate of the reels 3L, 3C, 3R. The start lever 6 can be tilted in any direction within a predetermined angle. Below the reels 3L, 3C, 3R are stop buttons 7L, 7C, 7R used to stop the rotation of the reels 3L, 3C, 3R. The stop buttons 7L, 7C, 7R correspond in position to the reels 3L, 3C, 3R, respectively.

The medal insertion slot 22 is provided on the right of the stop buttons 7L, 7C, 7R. At a top of the cabinet 2 are a pair of speakers 21L and 21R, and an LED lamp 29 disposed between the speakers 21L and 21R. Another speaker, a speaker 21B, is provided on the right of the medal discharge opening 15. The speakers 21L, 21R, and 21B play sounds and the LED lamp 29 emits light, for example, by flashing to produce various effects, which are given according to a gaming mode.

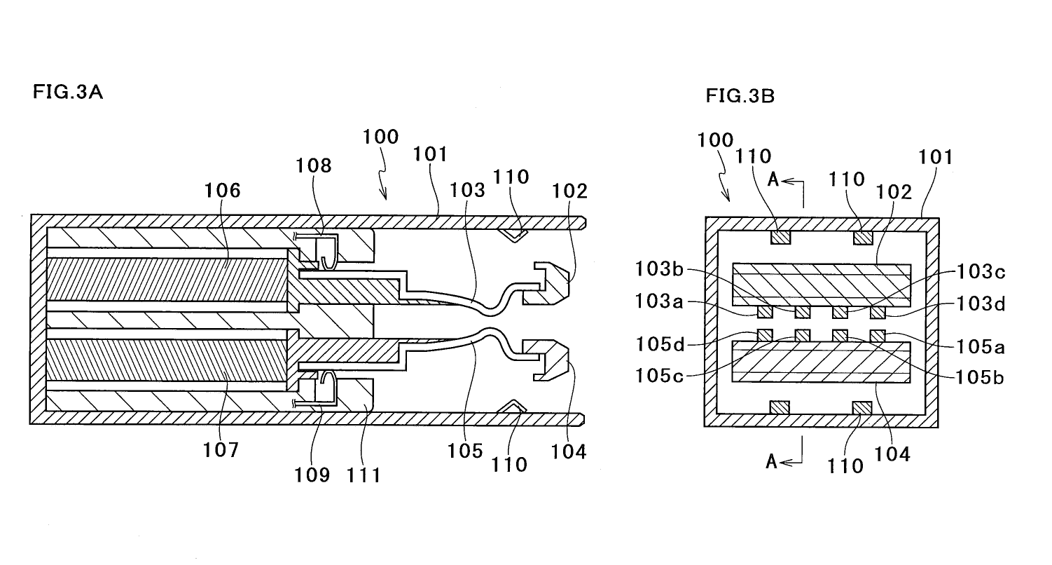

The following will describe the USB socket 100 of the present embodiment with reference to FIG. 2, FIG. 3A, and FIG. 3B.

As shown in FIG. 2 and FIG. 3A, the USB socket 100 includes a casing 101 in the shape of a hollow box with an opening on one side, a support member 111 provided inside the casing 101, a first female tongue 102 and a second female tongue 104 each supported by the support member 111, second electrode terminals 103 and third electrode terminals 105 respectively supported by the first female tongue 102 and the second female tongue 104, and arms 110.

The casing 101 houses a casing 301 of the USB plug 300 when it is inserted in the USB socket 100.

As shown in FIG. 2, the first and second female tongues 102 and 104 are plate members disposed parallel to the upper and lower walls of the casing 101. In the casing 101, the first and second female tongues 102 and 104 are provided parallel to each other with a gap in between, and are disposed to extend from a base wall (the wall on the left-hand side of FIG. 3A) of the casing 101 toward a contact opening (the opening on the right-hand side of FIG. 3A).

The second electrode terminals 103 include a power terminal 103a for supplying a voltage ranging from 4.75 to 5.25 volts (V), first and second signal terminals 103b and 103c, and a ground 103d, as shown in FIG. 3B. These terminals 103a, 103b, 103c, and 103d are provided side by side on the first female tongue 102.

The third electrode terminals 105 include a power terminal 105a for supplying a voltage of 4.75 to 5.25 volts (V), first and second signal terminals 105b and 105c, and a ground 105d, as shown in FIG. 3B. These terminals 105a, 105b, 105c, and 105d are provided side by side on the second female tongue 104.

As shown in FIG. 3B, the terminals of the second electrode terminals 103 and the terminals of the third electrode terminals 105 are face to face with each other, so that these terminals are in contact with first electrode terminals 303a, 303b, 303c, and 303d, respectively, of the USB plug 300 (see FIG. 2) when the USB plug 300 is inserted into the USB socket 100.

A total of four arms 110 are provided in the vicinity of the contact opening of the casing 101, two on the upper wall and two on the lower wall. The arms 110 project out of the upper and lower walls of the casing 101 into the spacing therein, so that, when the USB plug 300 is inserted to the USB socket 100, the arms 110 interlock with arm holes 310 respectively formed on upper and lower walls of the casing 301 of the USB plug 300.

The support member 111, in contact with the base wall of the casing 101 and the portions of the side walls in the vicinity of the base wall, is fixed on the casing 101 by being fitted thereto. Along the longitudinal direction of the casing 101, the support member 111 extends to substantially the center of the casing 101 from the base wall. Inside the support member 111 are provided springs 106 and 107, by which the first and second female tongues 102 and 104 are urged to be pushed, respectively, toward the contact opening, away from the base of the casing 101. In other words, the first and second female tongues 102 and 104 are supported by the support member 111 so as to be movable along the longitudinal direction of the casing 101, i.e., along the direction of insertion and detachment of the USB plug 300 with respect to the USB socket 100. The support member 111 also includes contact maintaining terminals 108 and 109, which remain in contact with the second and third electrode terminals 103 and 105, respectively, when the first and second female tongues 102 and 104 are moved along the direction of insertion and detachment.

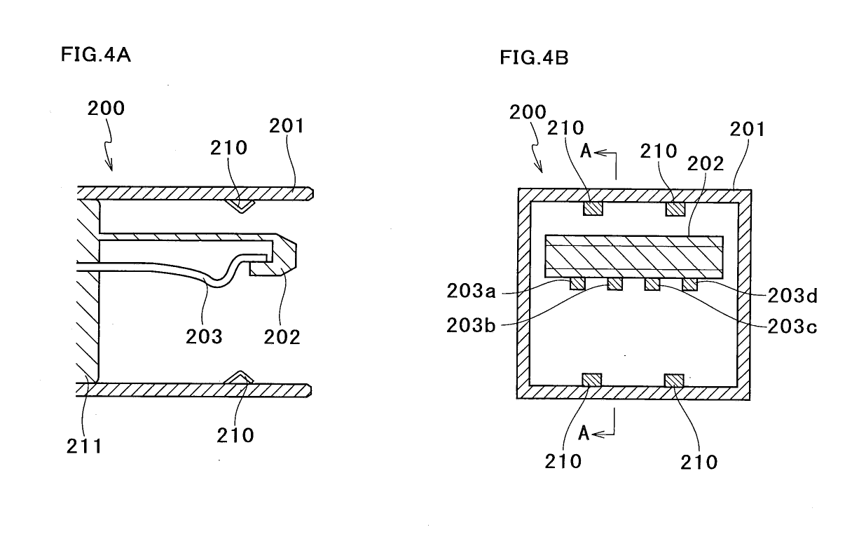

An example of a conventional USB socket is described below with reference to FIG. 4A and FIG. 4B.

A conventional USB socket 200 differs from the USB socket 100 of the present embodiment in that only one female tongue 202 is provided, and that no springs are provided in a support member 211 in a casing 201. The USB socket 200 does not differ from the USB socket 100 in regard to electrode terminals 203, including terminals 203a, 203b, 203c, and 203d, disposed side by side on a female tongue 202, and a total of four arms 210 provided in the vicinity of the contact opening of the casing 201, two on the upper wall and two on the lower wall.

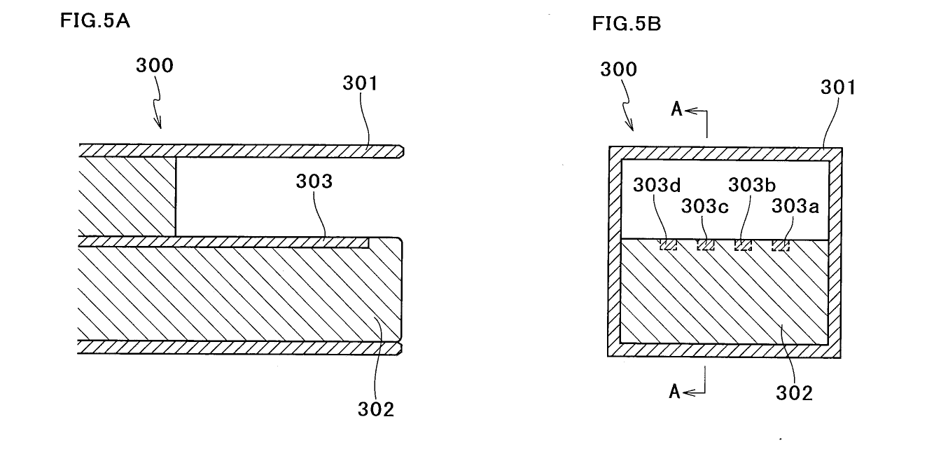

The following will describe the USB plug 300 with reference to FIG. 2, FIG. 5A, and FIG. 5B.

The USB plug 300 includes the casing 301, rectangular in shape, a male tongue 302 provided inside the casing 301, the first electrode terminals 303 supported on the male tongue 302, and the arm holes 310.

The male tongue 302, in contact with the lower wall of the casing 301 and the portions of the side walls in the vicinity of the lower wall, is fixed on the casing 301 by being fitted thereto. The male tongue 302 extends along the longitudinal direction of the casing 301, spanning the entire length of the casing 301. That is, inside the casing 301, substantially the lower half is occupied by the male tongue 302, whereas substantially the upper half is a hollow space.

The arm holes 310 are apertures provided through the upper and lower walls of the casing 301, serving as receptacles for the arms 110, 210 when the USB plug 300 is inserted to the USB socket 100, 200.

In order to connect the conventional USB socket 200 and the USB plug 300, the USB plug 300 needs to be inserted into the casing 201 of the USB socket 200 by correctly mating it with the USB socket 200, so that the female tongue 202 of the USB socket 200 is in register with the upper hollow space inside the casing 301 of the USB plug 300. In short, the USB plug 300 and the conventional USB socket 200 have directionality. For example, when the USB socket 200 is rotated 180 degrees from the state shown in FIG. 4B, the female tongue 202 would collide with the male tongue 302, making it impossible to insert the USB plug 300 into the casing 201 of the USB socket 200.

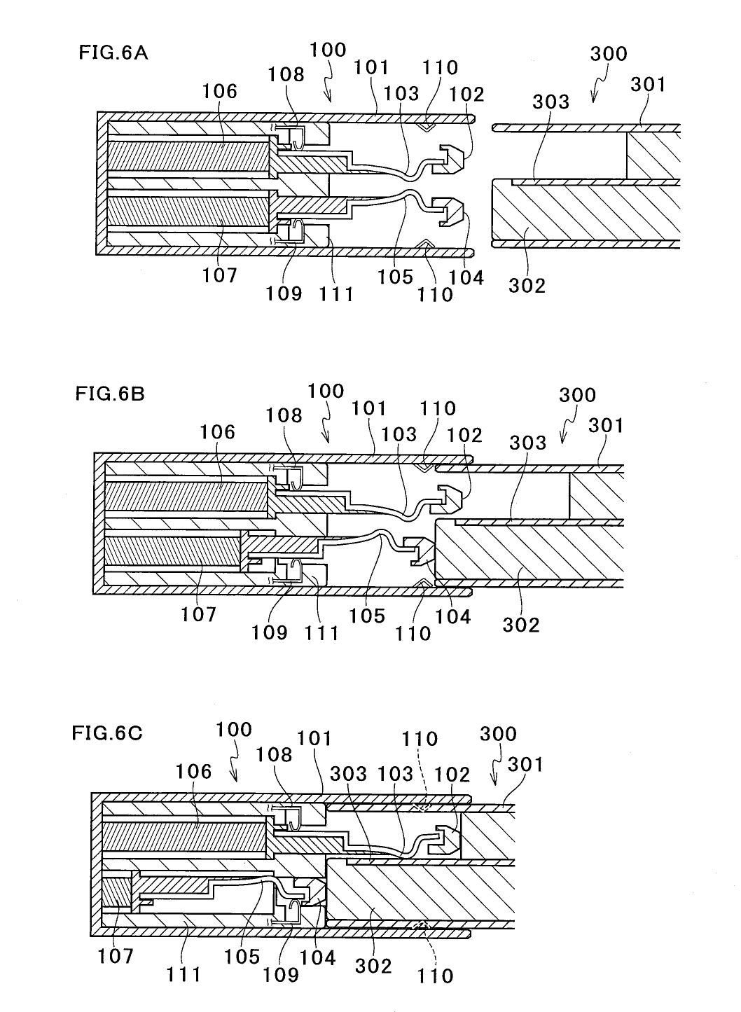

The following will describe how the USB socket 100 according to the present embodiment is connected to the USB plug 300, with reference to FIG. 6A, FIG. 6B, and FIG. 6C. In the present embodiment, the term “regular orientation” is used to refer to the orientation of the USB plug 300 having the male tongue 302 at the bottom as shown in FIG. 2, and “inverted orientation” is used to refer to the orientation of the USB plug 300 having the male tongue 302 on top. FIG. 6A through FIG. 6C show how the USB plug 300 is inserted into the USB socket 100 in a regular orientation.

First, the USB plug 300 is moved toward the USB socket 100 in register therewith, such that the contact openings of the USB plug 300 and the USB socket 100 are face to face with each other and the casing 301 is housed inside the casing 101 (see FIG. 6A and FIG. 6B)

As the casing 301 is inserted into the casing 101, the male tongue 302 is brought into contact with the second female tongue 104. The male tongue 302 pushes the second female tongue 104 in the direction of insertion of the USB plug 300, while the first female tongue 102 enters the hollow space in the upper part of the casing 301. By being pushed with the male tongue 302, the spring 107 is compressed to exert a force against the second male tongue 104. The direction of force is from the base of the casing 101 toward the contact opening, i.e., in the direction of detachment of the USB plug 300 from the USB socket 100 (to the right in FIG. 6A to FIG. 6C).

The arms 110 are temporarily retracted into the casing 110 when in contact with the front end of the casing 301. The USB plug 300 and the USB socket 100 are connected when the USB plug 300 is completely inserted into the USB socket 100, as shown in FIG. 6C. Here, the arms 110 are fitted to the arm holes 310 to fasten the casing 101 to the casing 301. The second electrode terminals 103 are in contact with the first electrode terminals 303 to make electrical connections.

The reverse of the foregoing operation is performed to detach the USB plug 300 from the USB socket 100. By the detachment of the USB plug 300, the second female tongue 104 is pushed back by the spring 107 to the initial position shown in FIG. 6A, in the direction of detachment of the USB plug 300.

When the USB plug 300 is inserted into the USB socket 100 in an inverted orientation, the male tongue 302 pushes the first female tongue 102, rather than the second female tongue 104, into the direction of insertion of the USB plug 300. Instead of the first female tongue 102, the second female tongue 104 enters the hollow space in the upper part of the casing 301. By being pushed with the male tongue 302, the spring 106, rather than the spring 107, is compressed in the direction of insertion to exert a force against the first female tongue 102 in the opposite direction. When the USB plug 300 is detached from the USB socket 100, the first female tongue 102 is pushed back by the spring 106 to the initial position shown in FIG. 6A, in the direction of detachment of the USB plug 300.

As described, the USB socket 100 of the present embodiment enables the USB plug 300 to be inserted in either a regular or an inverted orientation. Specifically, as shown in FIG. 6A through FIG. 6C, when the USB plug 300 is inserted into the USB socket 100 in a regular orientation, the male tongue 302 of the USB plug 300 pushes the second female tongue 104 of the USB socket 100 to make electrical connections between the second electrode terminals 103 of the first female tongue 102 of the USB socket 100 and the first electrode terminals 303 of the USB plug 300. On the other hand, when the USB plug 300 is inserted into the USB socket 100 in an inverted orientation, i.e., when the USB plug 300 is inserted upside down with respect to the orientation shown in FIG. 6A through FIG. 6C, the male tongue 302 of the USB plug 300 pushes the first female tongue 102 of the USB socket 100 to make electrical connections between the third electrode terminals 105 of the second female tongue 104 of the USB socket 100 and the first electrode terminals 303 of the USB plug 300. This eliminates the need to check the orientation of the USB socket 100 when inserting the USB plug 300 into the USB socket 100, making it easy to insert the USB plug 300.

Further, by the provision of the springs 106 and 107 in the USB socket 100, the first or second female tongue 102, 104 that has been pushed by the insertion of the USB plug 300 automatically returns to its initial position by being pushed back by the spring 106 or 107 when the USB plug 300 is detached from the USB socket 100. This is advantageous in terms of operability because it eliminates the need to, for example, manually set the first or second female tongue 102, 104 to the initial position.

Despite that the USB socket 100 is provided on the back side of the gaming machine 1 in the present embodiment, the foregoing configuration of the USB socket 100 enables the USB plug 300 to be easily inserted into the USB socket 100 without the annoying task of stretching over to see the back of the gaming machine 1. In other words, a user is able to easily insert the USB plug 300.

For the same reasons, in the game system 500 of the present embodiment, the USB plug 300 can easily be inserted into the USB socket 100 of each gaming machine 1 of the gaming system 500.

Preferably, the force exerted by the springs 106 and 107 should be appropriately set such that it allows the first or second female tongue 102, 104 to automatically return to the initial position when the USB plug 300 is detached from the USB socket 100, but does not break the connection between the USB plug 300 and the USB socket 100. For example, when the force exerted by the springs 106 and 107 is stronger than the force that holds the casings 101 and 301 by the fitting of the arms 110 and the arm holes 310 (the force acting to prevent detachment of the USB plug 300), the force of the spring 106 or 107 breaks the connection between the USB plug 300 and the USB socket 100. When the force of the springs 106 and 107 is too small, the first or second female tongue 102, 104 will not automatically return to the initial position when the USB plug 300 is detached from the USB socket 100. It is therefore preferable that the force of the springs 106 and 107 be appropriately set to prevent such undesirable situations.

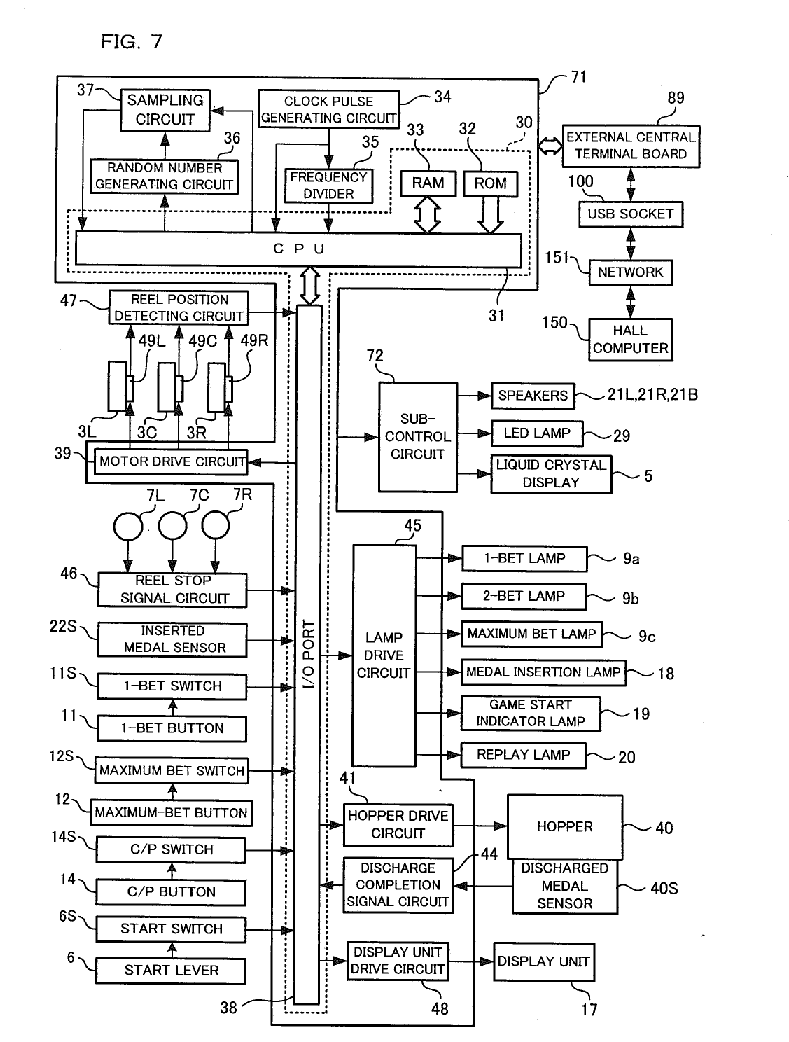

In the following, an electrical configuration of the gaming machine 1 will be described with reference to FIG. 7.

The gaming machine 1 includes a main-control circuit 71, and a sub-control circuit 72 provided on a sub-board. The main-control circuit 71 includes a micro computer 30 provided on a circuit board, and a circuit for random number sampling, among other members. The micro computer 30 includes a CPU 31 which performs control operations according to pre-set programs. A ROM 32 and the RAM 33 are also included in the micro computer 30.

In the main-control circuit 71, the CPU 31 is connected to a clock pulse generating circuit 34 for generating a reference clock pulse, a frequency divider 35, a random number generating circuit 36 for generating random numbers to be sampled, and a sampling circuit 37. The random number generating circuit 36 generates random numbers of a certain numerical range. The sampling circuit 37 samples a random number at an appropriate timing after the start lever 6 has been manipulated. The CPU 31 determines a combination for an internal win based on the random numbers generated by the random number generating circuit 36 and sampled by the sampling circuit 37, and a probability sortition table stored in the ROM 32.

Random numbers may be sampled within the micro computer 30, i.e., on the computer program executed by the CPU 31. In this case, the random number generating circuit 36 and the sampling circuit 37 may be omitted, or may be provided for the backup of the sampling operation.

The RAM 33 is a temporary storage for various kinds of information, such as a gaming mode, the number of medals inserted to the gaming machine 1 to play a game, and the number of medals acquired in a game.

The ROM 32 stores various data tables, including the probability sortition table used for the determination of the random number sampling performed at every manipulation of the start lever 6, and a group of stop tables for determining the stop of the reels 3L, 3C, and 3R according to the pressing of the stop buttons. The ROM 32 also includes various kinds of control commands to be sent to the sub-control circuit 72, and programs that are executed to perform each process routine of a main routine, as will be described later.

Control signals from the micro computer 30 control the operations of various constituting elements including the 1-BET lamp 9a, the 2-BET lamp 9b, the maximum BET lamp 9c, the medal insertion lamp 18, the game start indicator lamp 19, the replay lamp 20, the display unit 17, a hopper 40, and stepping motors 49L, 49C, 49R. The hopper 40 discharges a predetermined number of medals through the medal discharge opening 15. The stepping motors 49L, 49C, 49R are provided to drive the reels 3L, 3C, 3R, respectively.

The main-control circuit 71 includes a motor drive circuit 39 for driving the stepping motors 49L, 49C, 49R, a hopper drive circuit 41 for driving the hopper 40, a lamp drive circuit 45 for driving the lamps 9a through 9c, and 18 through 20, and a display unit drive circuit 48 for driving the display unit 17. These drive circuits 39, 41, 45, and 48 are connected to the CPU 31 via an I/O port 38, and control corresponding elements in response to the control signals sent from the CPU 31. The main-control circuit 71 also includes a discharge completion signal circuit 44, connected to the CPU 31 via the I/O port 38. The discharge completion signal circuit 44 receives the count data obtained by a discharged medal sensor 40S by counting the number of medals discharged from the hopper 40, and transmits a medal discharge completion signal to the CPU 31 when the data has a predetermined numerical value.

Via the I/O port 38, the CPU 31 is connected to a start switch 6S, a 1-BET switch 11S, a maximum BET switch 12S, a C/P switch 14S, an inserted medal sensor 22S, a reel stop signal circuit 46, and a reel position detecting circuit 47.

The start switch 6S detects manipulation of the start lever 6. The 1-BET switch 11S, the maximum BET switch 12S, and the C/P switch 14S detect pressing of the 1-BET button 11, the maximum-BET button 12, and the C/P button 14, respectively. The inserted medal sensor 22S detects the number of medals inserted to the medal insertion slot 22. The reel stop signal circuit 46 generates reel stop signals according to the pressing of the stop buttons 7L, 7C, 7R, respectively.

In response to pulse signals from a reel rotation sensor (not shown), the reel position detecting circuit 47 sends to the CPU 31 signals indicative of the positions of the reels 3L, 3C, and 3R. Based on the signals from the reel position detecting circuit 47, the CPU 31 grasps the current positions of the reels 3L, 3C, and 3R, and forwards the signals to the sub-control circuit 72.

The main-control circuit 71 is connected to an external central terminal board 89. The external central terminal board 89 is connected to the USB socket 100. The USB socket 100 is connected to the network 151 via the USB plug 300. The network 151 is connected to the hall computer 150 and other gaming machines 1, among other devices. In the game system 500, each gaming machine 1 communicates with the hall computer 150 via the external central terminal board 89, the USB socket 100, the USB plug 300, and the network 151.

The gaming machine 1 has four kinds of gaming modes: “base gaming mode”; “replay time (RT) gaming mode”; “RB gaming mode”; and “BB gaming mode”. Basically, these gaming modes are distinguished from one another based on possible combinations of internal win, the probability of hitting an internal win for a replay, the kinds of bonuses that can be won, and the relationship between an internal win and winning.

Generally, the base gaming mode is a least favorable gaming mode to players because the expected value of “return” (the game value awarded to the player in exchange for the unit game value wagered by the player) is less than 1.

When there is an internal win for BB or RB and the player has not won BB or RB in the base gaming mode, combinations of symbols corresponding to BB or RB are generally allowed to line up on the activated lines in one or more games. When there is an internal win for BB or RB in the base gaming mode, the combinations for the internal win are set as internal carryover combinations and carried over to subsequent games. As used herein, “carrying over of the combinations for the internal win” means that the player can win BB or RB in subsequent games without hitting an internal win for BB or RB. For example, the player can win BB or RB even when the player hits an internal win for “lose”.

The BB gaming mode occurs when the player hits an internal win for BB and wins BB in the base gaming mode or RT gaming mode. The player wins BB when “red 7-red 7-red 7” or “blue 7-blue 7-blue 7” line up on the activated line in the base gaming mode. The BB gaming mode ends when a predetermined number of medals have been paid out. In the present embodiment, hitting an internal win for “red 7-red 7-red 7” and hitting an internal win for “blue 7-blue 7-blue 7” are independent events, and therefore these events may occur at the same time.

The RB gaming mode is a most favorable gaming mode to players because it has a high expected value of return. In the present embodiment, the RB gaming mode occurs when the player wins RB in the base gaming mode or RT gaming mode. Specifically, the player wins RB when “red 7-red 7-blue 7” line up on the activated line in the base gaming mode or RT gaming mode. A transition from the base gaming mode or RT gaming mode to the RB gaming mode occurs when a combination of bonus symbols appears on the activated line, for example.

The RT gaming mode occurs after the BB gaming mode or RB gaming mode. In the RT gaming mode, the probability of winning a replay, which awards a player an extra game without requiring a medal, is higher than in the base gaming mode. That is, in the RT gaming mode, the player has the better chance of playing games without spending medals, so that the number of medals can be increased bit by bit. The RT gaming mode ends when the player hits a “small win with cherry”, upon which a transition is made to the base gaming mode.

In the RT gaming mode, a notification effect may be performed to navigate the player not to win a “small win with cherry”. The RT gaming mode may be started at any time, not just after the BB gaming mode or RB gaming mode but, for example, when the player hits an internal win for BB or RB; when symbols for BB or RB line up; when certain symbols line up in the base gaming mode; when a predetermined number of games have been played after the previous BB gaming mode or RB gaming mode; or when a predetermined number of games have been played after certain symbols lined up in the previous base gaming mode.

The following will describe the gaming modes in relation to winning combinations of symbols and the number of payout medals. In the base gaming mode, the player has the chance of hitting “BB”, “RB”, “Replay”, “a small win with watermelon”, “a small win with bell”, and “a small win with cherry”. A “BB” is triggered when “blue 7-blue 7-blue 7” and “red 7-red 7-red 7” line up in the activated lines. The number of medals paid out to the player triggering BB or RB is zero.

A “Replay” is triggered when “Replay-Replay-Replay” line up. A player hitting a replay is awarded the same number of medals he/she has inserted, enabling the player to play another game without spending medals. The payouts for “a small win with watermelon”, “a small win with bell”, and “a small win with cherry” are six, ten, and six medals, respectively.

In the BB gaming mode, the player has the chance of hitting a “Replay”, “a small win with watermelon”, “a small win with bell”, and “a small win with cherry”. In the present embodiment, the player cannot win BB or RB in the BB gaming mode.

In the RB gaming mode, the player has the chance of hitting a “Replay”, “a small win with watermelon”, “a small win with bell”, and “a small win with cherry”. The payouts for “a small win with watermelon”, “a small win with bell”, and “a small win with cherry” are six, ten, and six medals, respectively. In the present embodiment, the player cannot win BB or RB in the RB gaming mode.

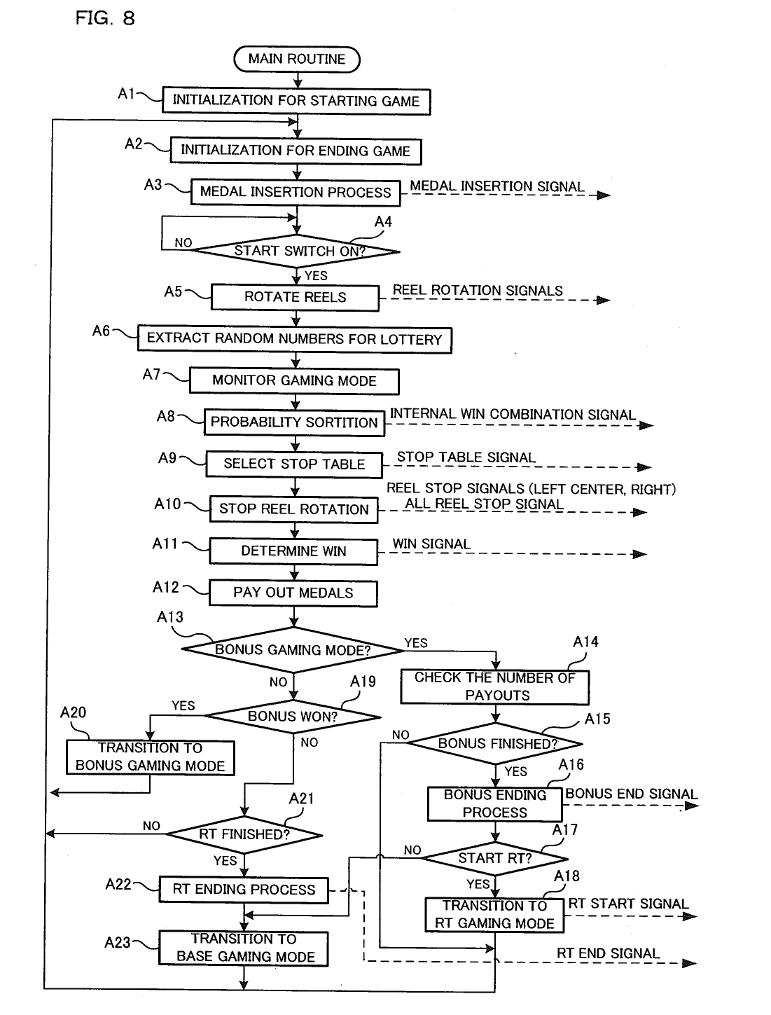

The following will describe the main routine executed by the gaming machine 1, with reference to FIG. 8.

Upon activation, the main-control circuit 71 of the gaming machine 1 executes the main routine to make the gaming machine 1 ready to play. The sub-control circuit 72 executes suitable effect process routines and causes the liquid crystal display 5 to display video effects or the like, the speakers 21L, 21R, 21B to play sounds, and the LED lamp 29 to emit light by flashing, for example.

In the main routine executed by the main-control circuit 71, the CPU 31 performs the following control procedures. First, the CPU 31 performs initialization for starting a game (A1). Specifically, the CPU 31 initializes the contents of the RAM 33, communication data, and the like. After A1, the predetermined contents of the RAM 33 loaded in the previous game are erased (A2). Specifically, the CPU 31 erases the data in a writable area of the RAM 33 used in the previous game, writes necessary parameters for the next game into a write area of the RAM 33, and designates a start address for the sequence program of the next game, among other things. After A2, the sequence waits until an input is made through the inserted medal sensor 22S or the BET switch 11S, 12S (A3). Upon receipt of a medal insertion signal from the inserted medal sensor 22S, the medal insertion signal is sent to the hall computer 150 via the USB socket 100 and other members. Then, it is determined whether the start switch 6S has been turned on by the manipulation of the start lever 6 (A4).

If the start switch 6S has not been turned on (NO in A4), the CPU 31 repeats the process of A4. That is, the sequence waits until the start switch 6S is turned on. If the start switch 6 has been turned on (YES in A4), the CPU 31 rotates the reels 3L, 3C, 3R, and sends reel rotation signals to the hall computer 150 via the USB socket 100 and other members (A5). After A5, random numbers for lottery are sampled (A6). In A7, the CPU 31 monitors a gaming mode. Specifically, the CPU 31 checks whether the current gaming mode is the base gaming mode, BB gaming mode, RB gaming mode, or RT gaming mode, and sets either of these gaming modes as a current gaming mode. The CPU 31 then sends a signal indicative of the gaming mode to the hall computer 150 via the USB socket 100 and other members. After A7, the CPU 31 performs probability sortition (A8). Specifically, the CPU 31 determines a combination for an internal win according to the probability sortition table and the gaming mode, and sends a signal indicative of the combination to the sub-control circuit 72. In the present embodiment, a combination for an internal win is determined independently, and as such there are cases where the internal win occurs in more than one combination.

In the present embodiment, the internal win can be both a small win and a bonus at the same time. An internal win for a bonus can be carried over; however, there is no carry over for an internal win for a small win. There is no stocking of an internal win for a bonus.

Thereafter, the CPU 31 selects one stop table from a group of stop tables stored in the ROM 32, based on the type of the combination for an internal win (A9). The stop table is used to stop the rotation of the reels 3L, 3C, 3R in a subsequent process. The CPU 31 then sends a stop table signal indicative of the selected stop table to the sub-control circuit 72. After A9, the CPU 31 stops the reels 3L, 3C, 3R (A10). Specifically, the CPU 31 determines the number of sliding symbols based on the type of the combination for an internal win, at the timing when any of the stop buttons 7L, 7C, 7R is pressed. The CPU 31 then stops the reel corresponding to the pressed stop button after sliding the number of symbols determined previously. The CPU 31 sends reel stop signals (left, center, right) to the sub-control circuit 72 every time the stop buttons 7L, 7C, 7R are pressed and the corresponding reels 3L, 3C, 3R are stopped. When the all reels 3L, 3C, 3R are stopped, the CPU 31 sends an all reel stop signal to the sub-control circuit 72.

After A10, the CPU 31 determines a win based on a total of nine, three rows and three columns of symbols appearing on the reels 3L, 3C, 3R that have come to rest (A11). The CPU 31 then sends a signal indicative of a type of win or the like to the hall computer 150 via the USB socket 100 and other members. After A11, the acquired medals are paid out (A12). This is accompanied by the display of the acquired medals on the display unit 17. A player presses the C/P button 14 to decide whether to reserve the acquired medals in the gaming machine 1 or discharge them through the medal payout opening 15. The reserved medals can be used in the next game by pressing the BET button 11 or 12. The payout is made only for the medals acquired by a small win, not for the medals acquired by a bonus win.

After A12, the CPU 31 determines whether the current gaming mode is the BB gaming mode or RB gaming mode (A13). If it is determined by the CPU 31 that the current gaming mode is the BB gaming mode or RB gaming mode (YES in A13), the CPU 13 checks the number of payouts for a bonus (A14).

After A14, the CPU 31 determines whether the bonus has been finished, based on the number of payouts checked in A14 (A15). If it is determined by the CPU 31 that the bonus has not been finished (NO in A15), the sequence goes to A2. If it is determined that the bonus has been finished (YES in A15), the CPU 31 performs a bonus ending process (A16). Specifically, the CPU 31 sends a bonus ending signal to the hall computer 150 via the USB socket 100 and other members.

After A16, the CPU 31 determines whether to start RT (A17). For example, when the bonus is BB, or when the bonus is RB and there was a predetermined combination of bells, replays, and the like in the previous game in RB, the CPU 31 determines to start RT. If the CPU 31 determines to start RT (YES in A17), the CPU 31 sends a RT start signal to the hall computer 150 via the USB socket 100 and other members, and a transition is made to the RT gaming mode (A18). The CPU 31 also sets a predetermined number of RT rounds according to the type of bonus. After A18, the sequence goes to A2 and the CPU 31 repeats the process.

If the CPU 31 determines not to start RT (NO in A17), a transition is made to the base gaming mode (A23). After A23, the sequence goes to A2 and the CPU 31 repeats the process.

If it is determined by the CPU 31 that the gaming mode is neither the BB gaming mode nor the RB gaming mode (NO in A13), the CPU 31 determines whether a bonus has been won (A19). Specifically, the CPU 31 determines that a bonus has been won when the combination of symbols that has come to rest on the activated line is either “red 7-red 7-red 7” or “blue 7-blue 7-blue 7”. If it is determined by the CPU 31 that a bonus has been won (YES in A19), a transition is made to the bonus gaming mode (A20). After A20, the sequence goes to A2 and the CPU 31 repeats the process.

If it is determined by the CPU 31 that a bonus has not been won (NO in A19), the CPU 31 determines whether RT has been finished (A21). Specifically, the CPU 31 determines that RT has been finished when the number of RT rounds is “0” or a player has won a cherry. If it is determined by the CPU 31 that RT has not been finished (NO in A21), the CPU 31 makes a subtraction from the number of RT rounds stored in the RAM 33. The sequence then goes to A2 and the CPU 31 repeats the process. If it is determined by the CPU 31 that RT has been finished (YES in A21), the CPU 31 performs a RT ending process (A22). The CPU 31 then sends a RT end signal to the hall computer 150 via the USB socket 100 and other members. After A22, a transition is made to the base gaming mode by the CPU 31 (A23). The sequence then goes to A2 and the CPU 31 repeats the process.

Note that, first and second urging members are not just limited to the springs 106 and 107 described herein, as long as the first and second female tongues are urged to be pushed. For example, rubbers or the like may be used.

The first and second female tongues, supported by the support member 111 in this embodiment, are not limited to this configuration.

As described herein, the signals sent to the hall computer 150 via the USB socket 100 are the medal insertion signal, the reel rotation signals, the gaming mode signal, the win signal, the bonus end signal, the RT start signal, the RT end signal, and the like. However, the signals are not limited to these examples.

The gaming machine 1 according to the present embodiment displays symbols using the mechanical reels 3L, 3C, 3R. However, the invention is not limited to this configuration. The gaming machine 1 may use video reels, or a combination of mechanical reels and video reels. Various types of displays can be used to display video reels, including a liquid crystal display, a CRT (cathode-ray tube), and a plasma display device, for example.

A gaming machine according to the present invention may include at least one of:

a game value supplier for supplying a game value to a player when a predetermined game result is displayed;

an internal winning combination determinator for determining a predetermined combination as an internal winning combination based on a game start command signal;

a stop control unit for causing a variable display unit to display a winning mode based on the internal winning combination;

an effect display control unit for causing an effect display unit to display an effect mode associated with a game;

an announce display control unit for causing an announce display unit to display an announcing mode announcing a possibility that a specific game result will be displayed, before the specific game result is displayed in a game result display unit;

an announce display control unit for causing a notification display unit to display a notifying mode notifying a possibility that a specific game result will be displayed, before the specific game result is displayed in the game result display unit;

a display control unit for performing display control for the game result display unit;

a display stop command section, positioned to be operable by a player, for outputting a stop command signal for partially or completely stopping a variable display presented by the game result display unit or the variable display unit;

an internal winning combination carryover section for carrying over a specific combination, determined as an internal winning combination by the internal winning combination determinator in a predetermined game, to be used as an internal winning combination in the next game;

a specific combination accumulator for accumulating and storing the specific combination determined as an internal winning combination by the internal winning combination determinator; and

an accumulated specific combination winning section for making the specific combination accumulated and stored in the specific combination accumulator an internal winning combination.

The game result display unit may include the variable display unit, the effect display unit, the notification display unit, and the like. The display units, included in the game result display unit, may be provided as separate members, or may be display units (sprites, 3D objects with different depths, and the like) provided in one display device, or may be overlaid with one another. The game result display unit may include at least one selected from: one or more sounds; one or more lights; one or more colors; one or more images; one or more odors or the like; and one or more motions (vibrations, pressures).

The game value supplier includes a favorable condition generator, such as a program for supplying a game medium, and processes such as paying out of a game medium, storing game values to a magnetic card, and adding game points.

The display control unit may include the stop control unit, the effect display control unit, the notification display control unit, and the like. The control units, included in the display control unit, may be provided on one board, or may be separately provided on more than one board. The stop control unit may be provided on the same board the internal winning combination determinator is provided, or on a different board. The effect display control unit and the notification display control unit may be provided on the same board the internal winning combination determinator is provided, or on a different board.

The variable display unit displays either a still or a moving image, and it may include one or more symbol display units which display symbols either as a variable image or a fixed image. Examples of images displayed by the variable display unit include symbols in pachi-slot machines/Japanese slot-machines or video slots, and special graphics, sound graphics, and determining symbols in pachinko gaming machines, among others.

The display stop command section may output a signal that stops the variable display in one of, some of, or all of the effect display unit, the variable display unit, the notification display unit, and the like. One display stop command section may be provided for one or more display units, or more than one display stop command section may be provided for one display unit.

The favorable condition generator may be, for example, a program that determines the generation, continuation, or cancellation of favorable conditions, or a program that generates, continues, or ends favorable conditions, as long as it continuously presents favorable conditions to a player over a number of games. The internal winning combination determinator may include the internal winning combination winning section, the internal winning combination carryover section, the specific combination accumulator, the accumulated specific combination winning section, and the like.

A gaming machine of the present invention includes a pachinko gaming machine, a pachi-slot machine/Japanese slot-machine, a video slot, and the like. The game result includes a winning mode, a lose mode, an effect mode, a notifying mode, and the like. A special win mode includes an indication with a specific symbol (“3”, “7”, and the like), an indication of a specific combination of symbols (“777”, “776”, and the like), an indication containing a specific symbol or specific symbols in a combination of symbols (one cherry, two consecutive cherries, and the like), and the like.

The lose mode includes modes other than the winning mode displayed in the variable display unit. The effect mode and notifying mode are other examples of the lose mode. The predetermined game result includes the winning mode, and the like. The effect mode is an entertaining mode intended to entertain a player during a standby time, during a game, between games, during a winning (including before and after the winning), and during the presentation of a favorable condition (including before and after the presentation). The effect mode also includes other modes such as a notifying mode notifying game information (game guide), as well as indications such as “jackpot”, “bonus”, “lose”, the number of continuations of favorable conditions, and the like.

The announcing mode includes a mode announcing a possibility that a predetermined or a specific internal winning combination has been determined, a mode announcing a loss, and an effect mode for these modes. Other examples of the announcing mode include indications such as “loss?”, “bell?”, “won a jackpot?”, “won a bonus?”, and “won a navigation function for game procedures?”. The notifying mode includes a mode notifying a player that a predetermined or a specific internal winning combination has been determined, a mode notifying a player that a predetermined or a specific internal winning combination has not been determined, and an effect mode for these modes. Other examples of the notifying mode include indications such as “won a jackpot”, “won a bonus”, “you lost”, “won a bell”, and “won a navigation function for game procedures?”.

The “mode” includes one or more still/moving images of symbols, one or more still/moving images of characters, one or more still/moving images of backgrounds, one or more still/moving images of balloons, one or more alphabets, one figure, a predetermined motion or the like of one or more movable objects, activation, flashing, or the like of one or more lamps, and sounds or the like from one or more speakers. The game information includes a game concept (game background), game rules, operation instructions, bonus ready hand, ready hand, descriptions of combination/replay, descriptions of favorable conditions (BB, RB, or the like), favorable conditions (BB, RB, or the like), probability, the number of games played since a predetermined time point (bonus, BB, RB, predetermined operation, and the like).

The game start command section includes switches such as a start lever and a spin button, insertion of a game medium, a symbol start gate, and the like. The display stop command section includes a button, a lever, a program, a timer, and the like. The symbol display unit includes a CRT, an LCD, a plasma display, a seven-segment display, a dot-matrix, a lamp, an LED, a fluorescent lamp, an EL, an electronic paper, a flexible LED, flexible liquid crystal, a liquid crystal projector, a reel, a disk, movable objects, and the like.

The internal winning combination includes one or more combinations determined as internal winning combinations from different combinations by the internal winning combination determinator. The winning combination includes a combination corresponding to the internal winning combination, displayed in a winning mode. The game value includes paying out a game medium, predetermined writing to a game result storage medium (magnetic card, and the like), a replay, adding points, generating favorable conditions, and the like. The game medium includes coins, medals, gaming balls, bills, magnetic cards, and the like.

As the combination in a gaming machine such as a “pachi-slot machine/Japanese slot-machine”, one or more of the following is applicable: lose; a small win, in which a predetermined number of media is paid out; one bonus, in which the probability that the internal winning combination determinator determines a small win as an internal winning combination is increased only during one game; a regular bonus, in which the probability that the internal winning combination determinator determines a small win as an internal winning combination is increased only during a number of games; a big bonus, in which the probability that the internal winning combination determinator determines a regular bonus as an internal winning combination is increased only during a number of games; an internal winning combination navigation function for notifying information concerning the internal winning combination determined by the internal winning combination determinator, before a player operates the display stop command section; a press sequence navigation function for notifying information concerning the stop pattern selected by a stop pattern selector, before a player operates the display stop command section; and a game procedure navigation function for notifying a game procedure that is advantageous to a player.

For example, the internal winning combination navigation function includes a reel stop navigation function or the like that presents a predetermined winning mode in the variable display unit by navigating a stop operation of the left, center, and right reel stop buttons according to the reel stop pattern notified before operating the left, center, and right reel stop buttons respectively corresponding to the left reel, center reel, and right reel (for example, six stop patterns including: stopping left reel→center reel→right reel; stopping left reel→right reel→center reel; stopping center reel→right reel→left reel; stopping center reel→left reel→right reel; stopping right reel→left reel→center reel; and stopping right reel→center reel→left reel). The reel stop navigation function includes a navigation function that notifies a player which reel to stop in what order (for example, first, second, or third), instead of navigating the complete order of stopping the reels (not only the reels but the image display unit variably displaying symbols). The reel stop navigation function also includes a function that presents a predetermined winning mode in the variable display unit when the reels, set to be stopped in a predetermined order, are stopped with predetermined symbols appearing thereon. The reel stop navigation function also includes a function for stopping symbols with the least displacement (or substantially the least variation) when a player outputs a stop command signal from the display stop command section. A replay allowing a player to start a game without inserting a game medium is also included in the reel stop navigation function.

The duration of one game may be as follows:

From the output of a game start command signal from the game start command section to the displaying of a game result;

From the manipulation of the start lever to the displaying of a game result in the variable display unit;

From the manipulation of the start lever to the displaying of a specific indication in a predetermined display unit;

From the output of a game start command signal initiated by the pressing of the bet button or the insertion of a game medal, to the displaying of a game result in the variable display unit;

From the output of a game start command signal initiated by the pressing of the bet button or the insertion of a game medal, to the displaying of a specific indication in a predetermined display unit;

From the detection of a win or the detection of the passage of a game medium by a symbol start section that outputs a game start command signal, to the displaying of a game result in the variable display unit; and

From the detection of a win or the detection of the passage of a game medium by a symbol start section that outputs a game start command signal, to the displaying of a specific indication in a predetermined display unit.

Games may be performed continuously or intermittently.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A USB socket as a receptacle for a directional USB plug including a male tongue provided with a first electrode terminal,
the USB socket comprising:
a first female tongue having a second electrode terminal, the second electrode terminal being electrically connected to the first electrode terminal when the USB plug is inserted into the USB socket in a regular orientation, and the first female tongue being pushed with the male tongue in a direction of insertion of the USB plug when the USB plug is inserted into the USB socket in an inverted orientation;
a second female tongue having a third electrode terminal, the second female tongue being pushed with the male tongue in the direction of insertion of the USB plug when the USB plug is inserted into the USB socket in the regular orientation, and the third electrode terminal being electrically connected to the first electrode terminal when the USB plug is inserted into the USB socket in the inverted orientation; and
a casing housing the first female tongue and the second female tongue such that the second electrode terminal and the third electrode terminal are face to face with each other.

2. The USB socket according to claim 1, further comprising:
a first urging member by which the first female tongue is urged to be pushed in a direction of detachment of the USB plug from the USB socket; and
a second urging member by which the second female tongue is urged to be pushed in the direction of detachment of the USB plug from the USB socket.

3. A gaming machine, comprising a cabinet including the USB socket of claim 1 on a back side of the cabinet, wherein the gaming machine is connected to a network via the USB socket.

4. A gaming system, comprising the gaming machine of claim 3 in a plurality, wherein the gaming machines are disposed side by side with side faces of the cabinets facing one another.
